(19) United States
(12) Patent Application Publication
(10) Pub. No.: US 2026/0147343 A1
(43) Pub. Date: May 28, 2026

(54) VEHICLE CONTROL SYSTEM AND METHOD

(71) Applicant: Transportation IP Holdings, LLC, Norwalk, CT (US)

(72) Inventors: James D. Brooks, Grove City, PA (US); Brian Nedward Meyer, Fairview, PA (US); Kirk Arnaldo Heywood, Roanoke, TX (US)

(73) Assignee: Transportation IP Holdings, LLC, Norwalk, CT (US)

(21) Appl. No.: 18/961,219

(22) Filed: Nov. 26, 2024

(51) Int. Cl. G05D 1/227; B60W 60/00

(52) U.S. Cl. CPC G05D 1/227; B60W 60/001; B60W 2556/45

(57) ABSTRACT

A vehicle control system is disclosed that includes an onboard control circuit that can implement commands for controlling movement of a vehicle. The onboard control circuit can receive a remote operator command for controlling the movement of the vehicle from an offboard device and receive an onboard operator command for controlling the movement of the vehicle from an onboard control interface. The onboard control circuit can determine whether to implement the remote operator command or the onboard operator command.

### BACKGROUND

### Technical Field

Various aspects of the present disclosure relate to controlling a vehicle remotely.

### Discussion of Art

Many transportation segments are looking toward remote vehicle operations. For example, the automobile industry, the trucking industry, the rail industry, etc., are moving toward at least partial remote-control of vehicles such as automobiles, trucks, trains, or the like. While some industries may be looking toward self-driving vehicles, these same industries may be looking toward a backup solution where a remotely located operator is able to take control of a vehicle from afar (e.g., due to a system failure or other problem with the self-driving features of the vehicle). It may be desirable to have a system and method related to partial remote-control of a vehicle that differs from those that are currently available.

### BRIEF DESCRIPTION

In one or more embodiments, a vehicle control system is provided. The vehicle control system includes an onboard control circuit configured to implement commands for controlling movement of a vehicle. The onboard control circuit is further configured to receive a remote operator command for controlling the movement of the vehicle from an offboard device, receive an onboard operator command for controlling the movement of the vehicle from an onboard control interface, and determine whether to implement the remote operator command or the onboard operator command.

In one or more embodiments, a vehicle control system is provided. The vehicle control system includes an offboard device. The offboard device is configured to receive a remote control request from an onboard control circuit of a vehicle, and the remote control request includes a credential, establish a communication link for remotely controlling a movement of the vehicle based at least in part on validating the credential, and transmit a remote operator command through the communication link to the onboard control circuit to control the movement of the vehicle.

In one or more embodiments, an onboard control circuit for a vehicle is provided. The onboard control circuit configured to operate the vehicle based at least in part on a trip plan, establish a communication link with an offboard device using a credential, and transition control of the vehicle from the onboard control circuit to the offboard device.

### BRIEF DESCRIPTION OF THE DRAWINGS

Reference is made to the accompanying drawings in which similar components are indicated using the same reference numbers, and in which:

FIG. 1 illustrates a vehicle control system used to control movement of a vehicle system, according to one embodiment.

FIG. 2 is a schematic illustration of an onboard vehicle control system (OVCS), according to one embodiment.

FIG. 3 is a schematic illustration of a remote vehicle control system (RVCS), according to one embodiment.

FIG. 4 is a schematic illustration of a vehicle control system including an OVCS and a RVCS, according to one embodiment.

FIG. 5 illustrates a flow diagram of a method for requesting a remote operator to control movement of a vehicle system, according to one embodiment.

FIG. 6 illustrates a flow diagram of a method for establishing a secure communication link between an OVCS and a RVCS, according to one embodiment.

FIG. 7 illustrates a flow diagram of a method to verify that remote control of movement of a vehicle system by a RVCS is enabled, according to one embodiment.

FIG. 8 illustrates a flow diagram of a method for switching communication channels for communications between an OVCS and a RVCS, according to one embodiment.

FIG. 9 is a schematic illustration of a control scheme for managing remote commands, according to one embodiment.

FIG. 10 is a schematic illustration of a control scheme for managing commands based on a control hierarchy, according to one embodiment.

### DETAILED DESCRIPTION

Various aspects of the present disclosure relate to controlling a vehicle remotely. To control movement, a vehicle system may implement commands that are one or both of generated by an onboard control system and commands generated by an offboard (i.e., remote) control system. The system may determine how to address conflicts with commands from different sources. If the vehicle system has self-driving or autonomous control capabilities, there may be conflict if an operating condition makes it is desirable to switch from autonomous to manual control but no operator is present onboard the vehicle system.

Various subject matter disclosed herein relates to apparatus, systems, and methods for remotely controlling a vehicle system. In one embodiment, a vehicle can include an onboard control circuit as part of an onboard vehicle control system (OVCS). A suitable onboard control circuit can be communicatively coupled to an offboard control device and may implement commands for controlling movement of the vehicle. For example, the onboard control circuit can a receive remote operator command from the offboard control device and receive an onboard operator command from an onboard control interface. A suitable offboard control device may be a remote vehicle control system (RVCS). Both the remote operator command and the onboard operator command can control operations and movement of the vehicle. The onboard control circuit may determine whether to implement or allow the remote operator commands or continue with using the onboard operator commands.

In one embodiment, a vehicle control system can include a control circuit that may be included in or otherwise define an OVCS. The OVCS may execute commands to slow, stop or move the vehicle system. The control circuit can detect certain operating condition of the vehicles and transmit a remote control request to an offboard device. The control circuit can transition from the onboard control state to an offboard control state and receive, from the offboard device, a remote operator command for controlling a movement of the vehicle. The OVCS can switch operating modes to and from an onboard control state. Suitable onboard control states may include manual operations and an autonomous control state. Suitable operating conditions may include a fault condition, an obstruction in the path of the vehicle, anomalous sensor signals, lack of responsiveness from an onboard operator, communication path signal quality, and the like.

A suitable remote vehicle control system (RVCS) can include a control circuit, and may be referred to as an offboard control device. The offboard control device may receive a remote control request from a control circuit onboard a vehicle. The remote control request can include a credential. The offboard control device and the onboard control device may establish a secure communication link. The communication link may be used for validating the credential, and for remotely controlling movement of the vehicle after validating the credential.

This subject matter disclosed herein may be used in connection with rail vehicles and rail vehicle systems, while some embodiments may be used with other types of vehicles. Suitable other vehicles may include automobiles, on-road trucks, mining vehicles, other off-highway vehicles (e.g., vehicles that are not designed or are not legally permitted for travel on public roadways), aerial vehicles, and marine vessels. Movement of the vehicle may include propelling the vehicle forward or backward along a direction of travel, as well as slowing or stopping the vehicle. Movement further may include turning left or right, and increasing or decreasing elevation or depth. Movement further may include determining or setting a vehicle speed, changing a vehicle speed, matching speeds between vehicles. Indirectly, movement of the vehicle may include ramping up (or down) power sources; and this may include energizing electrical circuits or buses, setting fuel flow rates, setting engine RPM rates, and the like.

A suitable vehicle system can include two or more vehicles coupled with each other to travel along a route together. The coupling may be mechanical in one embodiment, and may be logical, virtual or communicative in another embodiment. For example, two or more vehicles may wirelessly communicate as they travel along the route together as a coordinated vehicle system that moves relative to each other. In one embodiment, a vehicle system may be formed from a single vehicle. In another embodiment, a first one of the vehicles in a plural vehicle system may be controlled remotely, and another vehicle in the system may be controlled based at least in part on the movement commands of the first vehicle. Alternatively, plural vehicles in the vehicle command may be controlled remotely such that movement coordination is not performed in a relative sense but rather simple directions that coordinate vehicle locations. Groups of two or more vehicle traveling together in a coordinated manner may be referred to as a consist, swarm, fleet, convoy, fleet and the like.

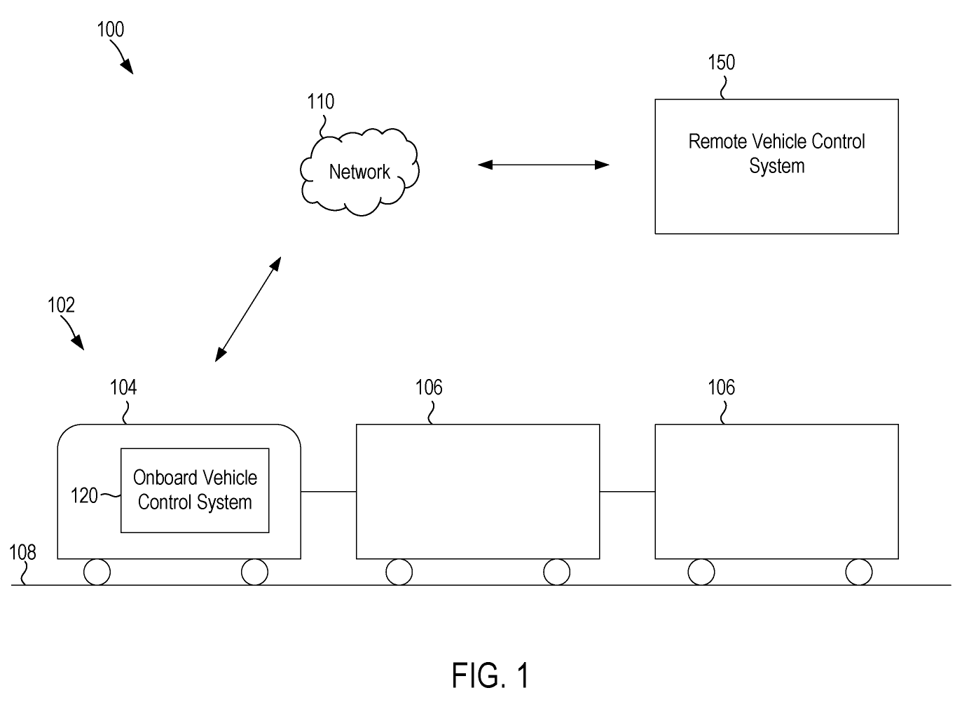

FIG. 1 illustrates one embodiment of a vehicle control system 100 used to control movement of a vehicle system 102. The vehicle system can represent any of the vehicle systems shown and/or described herein. The vehicle system includes a propulsion-generating vehicle 104 and one or more than one non-propulsion-generating vehicle 106 that travel together along a route 108. The propulsion-generating vehicle may be a locomotive while the non-propulsion-generating vehicles may be rail cars, and the vehicle system is shown as a train.

The vehicle system includes an onboard vehicle control system (OVCS) 120. A suitable OVCS can include a control circuit. The OVCS can control or limit movement of the propulsion-generating vehicle and/or the vehicle system based on one or more limitations. For example, the OVCS may prevent the vehicles and/or the vehicle system from entering a restricted area, may prevent the vehicle and/or vehicle system from exiting a designated area, may prevent the vehicle and/or vehicle system from traveling at a speed that exceeds an upper speed limit, may prevent the vehicle and/or vehicle system from traveling at a speed that is less than a lower speed limit, may slow or prevent the vehicle and/or vehicle system from traveling according to a designated trip plan.

The OVCS can be communicatively and/or operably connected with a remote vehicle control system (RVCS) 150 that is disposed offboard the vehicle system. The RVCS can represent any of the remote vehicle control systems described herein. The RVCS may remotely control movement of the vehicle system by communicating control signals comprising remote commands to the OVCS. One or more than one operator at the RVCS may remotely control the movement of the vehicle system using the RVCS. For example, multiple operators may remotely control multiple different vehicle systems.

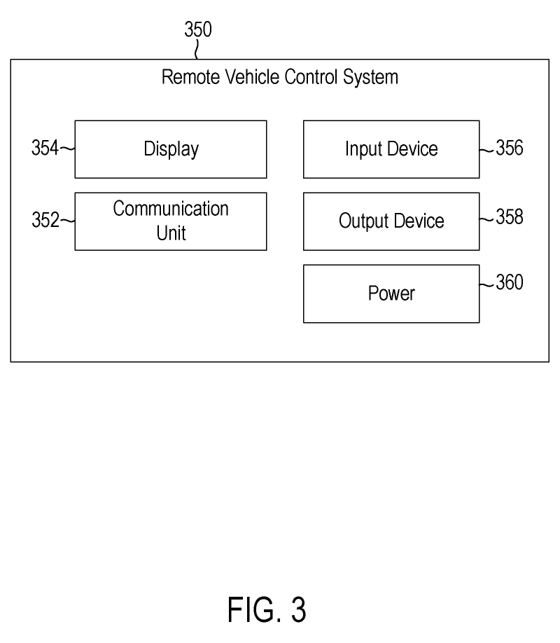

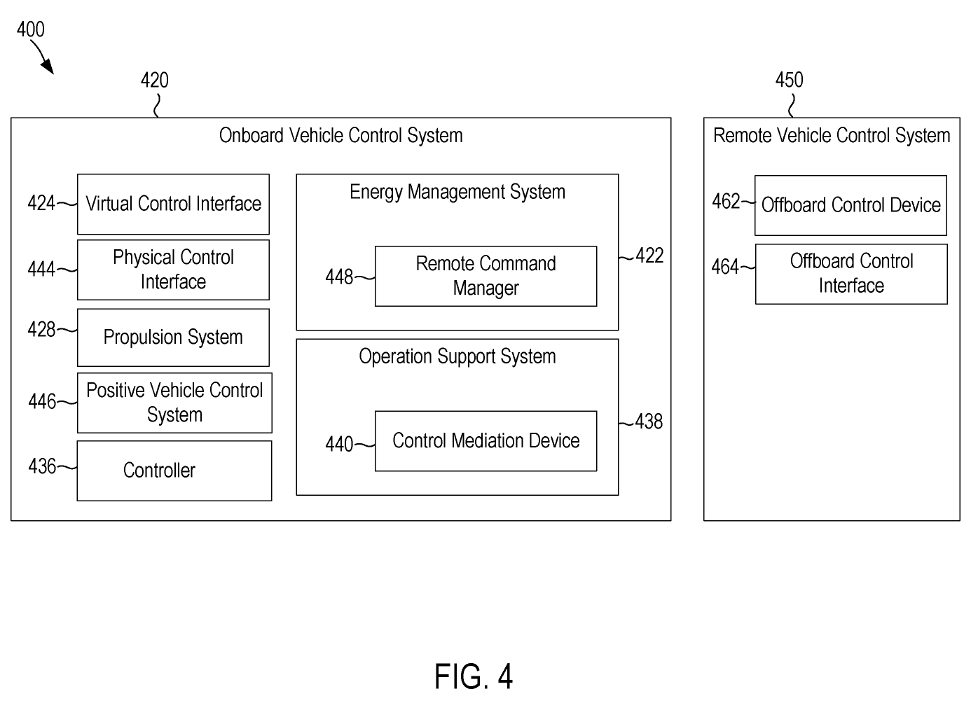

The RVCS may separated from the vehicle system by a distance. A suitable RVCS may be a desk system located in a back office, or a handheld device. The RVCS can be communicatively linked with the OVCS via a network 110. The RVCS can communicate control signals to the OVCS via the network to remotely control the movement of the vehicle system as the vehicle system travels along the route. The control signals can use remote commands that dictate the movement operational settings of the vehicle system, such as, for example, a throttle (e.g., notch) setting, a brake setting, speed setting, or the like. Various embodiments of the RVCS are discussed further herein, for example, with respect to FIGS. 3 and 4. The RVCS may receive video data streams, or other data streams, from the vehicle during operation in one embodiment.

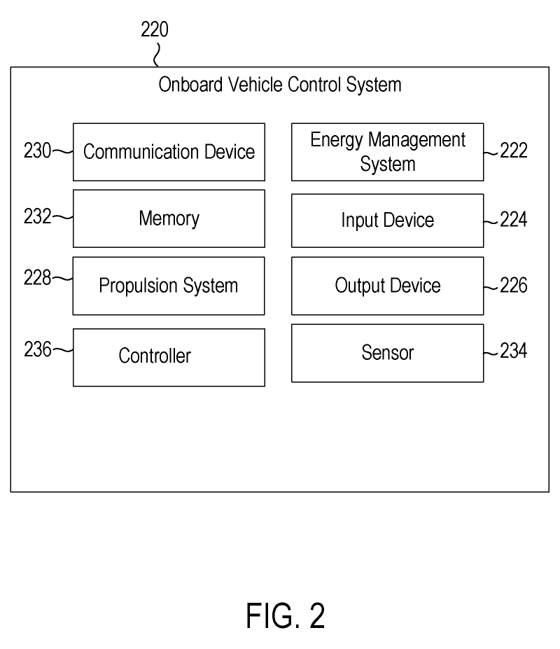

FIG. 2 is a schematic illustration of one embodiment of an onboard vehicle control system (OVCS) 220 that is disposed onboard the vehicle system. The OVCS can control the movement of the vehicle system. The OVCS can be controlled manually (e.g., by a human operator onboard the vehicle system) and/or autonomously with an energy management system (EMS) 222. For example, an operator onboard the vehicle system may manually control movement of the vehicle system by manually controlling the hardware, controllers, devices, or the like of the OVCS. Additionally or alternatively, the EMS may autonomously control movement of the vehicle system (e.g., without input by an operator onboard the vehicle system) by electrically communicating directions and/or commands to the systems and devices associated with the OVCS. As used herein, the term “operator” may refer to a human operator that provides commands for controlling the movement of the vehicle system and/or a system capable of providing commands for autonomously controlling the movement of the vehicle system (e.g., an EMS). A suitable EMS may be Trip Optimizer system, commercially available from Wabtec Corporation.

A suitable EMS can create a trip plan for a trip of the vehicle system and can control aspects of the vehicle system to operate the vehicle according to the trip plan. A trip plan may designate operational settings of the propulsion-generating vehicle and/or the vehicle system as a function of one or more of time, location, or distance along a route for a trip. Traveling according to the operational settings designated by the trip plan may reduce fuel consumed and/or emissions generated by the vehicle and/or the vehicle system relative to the vehicle and/or vehicle system traveling according to other operational settings that are not designated by the trip plan. The identities of the vehicle(s) in the vehicle system may be known to the EMS and/or identified by the EMS so that the EMS can control operations of the vehicle system. The control may be done autonomously, semi-autonomously, or may be used as guidance so that another operator may control the vehicle according to the trip plan. The EMS can determine what operational settings to designate for a trip plan to achieve a goal. Suitable goals may include reducing fuel consumed and/or emissions generated by the vehicle system during the trip. Other suitable goals may include vehicle handling, controlling intra-vehicle forces, arrival time at a destination, and the like.

The OVCS is connected with an input device 224 and an output device 226. A suitable OVCS may receive manual input from an onboard operator of the vehicle system through the input device. The input device can include one or more than one device such as a touchscreen, keyboard, electronic mouse, microphone, throttle, pedal, button, and/or other input devices. For example, the OVCS can receive manual inputs for changing a tractive effort, braking effort, speed, power output, and the like, from the input device.

The OVCS can present information to an operator of the vehicle system using the output device. The output device can include one or more than one device such as a display screen (e.g., touchscreen or other screen), a speaker, a printer, and/or other output devices. For example, the OVCS can present the identities and statuses of the vehicle(s) in the vehicle system, identities of missing vehicles (e.g., those vehicles from which the OVCS has not received the status), contents of one or more command messages, or the like. The output device can provide a notification signal to the operator of the vehicle system that automatically informs (e.g., notifies) the operator that control of the movement of the vehicle system has changed. For example, the output device may change colors, change a display format, ring a bell, communicate a vocal command, communicate a sound, or the like to indicate that the control of the movement of the vehicle system is and/or has transferred to or from an onboard control state (e.g., controlled by an onboard operator, controlled by the EMS) and an offboard control state (e.g., controlled remotely by the RVCS). Optionally, the output device can present instructions to an operator onboard the vehicle system from the OVCS that instruct the operator how to manually control the movement of the vehicle system. For example, the output device may instruct a throttle notch setting, speed setting, brake setting, or the like, to the operator of the vehicle system for the operator onboard the vehicle system to manually control the movement of the vehicle system.

The OVCS can include or otherwise be coupled to a propulsion system 228 of the propulsion-generating vehicle. The propulsion system may provide tractive effort and/or braking effort of the propulsion-generating vehicle. The propulsion system can include one or more of engines, motors, alternators, generators, brakes, batteries, turbines, fuel cells, fuel systems, and the like. Components of the propulsion system may operate to propel the propulsion-generating vehicle and/or the vehicle system responsive to the OVCS and/or the RVCS. For example, the OVCS can direct operations of the propulsion system by the OVCS generating control signals autonomously or based at least in part on manual input by an onboard operator or a remote operator.

The OVCS includes a controller 236 that can receive signals from the input device and/or the EMS, and based at least in part on the signals from the input device and/or the EMS, the controller can control settings of propulsion system to control movement of the vehicle system. The OVCS further can include a memory 232 and a communication device 230. The communication device can include or represent hardware and/or software that is used to communicate with other vehicles in the vehicle system and/or communicate with the RVCS via the network. For example, the communication device may include a transceiver and associated circuitry for wirelessly communicating linking messages, command messages, reply messages, repeat messages, or the like. Optionally, the communication device includes circuitry for communicating messages over a wired connection, such as an electric multiple unit (eMU) line of the vehicle system (not shown), catenary or third rail of electrically powered vehicles, or another conductive pathway between or among the vehicles of the vehicle system and/or between or among vehicles of a different vehicle system.

The OVCS may control the communication device by activating the communication device. The OVCS can examine the messages that are received by the communication device from the RVCS and/or other vehicles in the vehicle system.

The OVCS can include or otherwise be connected with one more than one sensor 234 and can include software and/or circuitry that include and/or are connected with one or more processors. The sensor can be an object detection sensor. The sensor can obtain sensor data that is indicative of an area outside of the vehicle system. For example, the sensor may obtain sensor data in an area in front of the vehicle system relative to a direction of travel of the vehicle system, in an area behind the vehicle system relative to a direction of travel of the vehicle system, or the like. The sensor may include a camera that obtains still and/or motion visual data of an area of the route in the direction of travel of the vehicle system and/or in a direction opposite the direction of travel of the vehicle system. For example, the sensor can include one or more than one camera that captures still images in the front (e.g., in the direction of travel) and the rear (e.g., opposite the direction of travel) of the vehicle system. Optionally, the sensor may include a radar system that sends and receives pulses reflected off of an object in order to detect a presence and/or location of an object in an area outside of the vehicle system. Optionally, the sensor may be an alternative sensing system that obtains data of an area outside of the vehicle system. The sensor may obtain data (e.g., visual, statistical, radar, or the like) a distance of 2 meters, 25 meters, 100 meters, 500 meters, 1000 meters, or the like outside of and in a direction away from the vehicle system.

The sensor may include one or more than one sensing device positioned around the vehicle(s) on one or more of the interior and/or exterior of the vehicle(s) (not shown). For example, a sensing device may be positioned on a front and/or rear end of the vehicle(s) to obtain data for the vehicle(s) and/or the vehicle system that travels in a first direction and an opposite second direction (e.g., back and forth). Optionally, one or more sensing devices may be used, and the placement of the one or more sensing devices may vary.

FIG. 3 is a schematic illustration of one embodiment of a remote vehicle control system (RVCS) 350 that may be disposed offboard the vehicle system. The RVCS may remotely control the movement of the vehicle system by communicating with the OVCS. The RVCS is or can include a control circuit. The RVCS can generate control signals that are communicated to the OVCS by a communication unit 352. The control signals can comprise commands for remotely control movement of the vehicle system. The communication unit can send communication signals to and/or receive communication signals from OVCS via the network. The RVCS can receive image data and/or sensor data detected by the sensor onboard the vehicle system. For example, the RVCS may receive visual data representative of an area outside of the vehicle system that is obtained by an object detection sensor and communicated by the OVCS. Optionally, the RVCS may receive status notifications such as vehicle system equipment statuses, current vehicle and/or vehicle system operational settings, a vehicle system location, or the like, of the vehicle system and/or of the vehicle(s) of the vehicle system.

The RVCS can include an input device 356 and/or an output device 358. The RVCS can receive manual input from a remote operator of the vehicle system through the input device. The input device can include one or more than one device such as a touchscreen, keyboard, electronic mouse, microphone, and/or other input devices. For example, the RVCS can receive inputs from the remote operator and generate command signals that are transmitted to the OVCS to change the tractive effort, braking effort, speed, power output, and the like, of the vehicle system.

The RVCS can present information to a remote operator of the vehicle system using the output device. The output device can include one or more than one device such as a display screen (e.g., touchscreen or other screen), a speaker, a printer, and/or other output devices. For example, the RVCS can present the identities and statuses of the vehicle(s) in the vehicle system, identities of missing vehicles (e.g., those vehicles from which the OVCS has not received the status), contents of one or more command messages, or the like. The output device can provide a notification signal to the remote operator of the vehicle system that automatically informs (e.g., notifies) the remote operator that control of the movement of the vehicle system has changed. For example, the output device may change colors, change a display format, ring a bell, communicate a vocal command, communicate a sound, or the like to indicate that the control of the movement of the vehicle system has transferred to or from an offboard operating state (e.g., controlled by the RVCS) and an onboard operating state (e.g., controlled by an onboard operator, controlled by the EMS).

The input and/or output device of the RVCS can be used by a remote operator to communicate with an operator onboard the vehicle system via the input device and/or output device of the OVCS. For example, the RVCS can be used by the remote operator to supervise, train, instruct, evaluate, or otherwise monitor (e.g., perform a checkride) an operator onboard the vehicle system. This can eliminate a need for an operator (e.g., a human operator) to be onboard the vehicle system to supervise, train, instruct, evaluate, or otherwise monitor another onboard operator. In some examples, the RVCS may be used by a remote operator for supervising an onboard operator without the RVCS remotely controlling movement of the vehicle system.

The RVCS can include a power unit 360. The power unit powers RVCS. For example, the power unit may be a battery and/or circuity that supplies electrical current to power components of the RVCS.

FIG. 4 is a schematic illustration of one embodiment of a vehicle control system 400. The vehicle control system can represent or otherwise be implemented by any of the vehicle systems shown and/or described herein. The vehicle control system can be used to control movement of a vehicle system (e.g., the vehicle control system illustrated by FIG. 1). The vehicle control system includes an onboard vehicle control system (OVCS) 420 that is disposed onboard the vehicle system and a remote vehicle control system 450 (RVCS) that is disposed offboard the vehicle system. Any aspects of the OVCS discussed with respect to the embodiment of FIG. 4 can be included or otherwise be implemented by any OVCS shown and/or described herein, and vice versa. Any aspects of the RVCS discussed with respect to the embodiment of FIG. 4 can be included or otherwise be implemented by any RVCS shown and/or described herein, and vice versa.

The OVCS can include an energy management system (EMS) 422. The EMS in the embodiment of FIG. 4 can be similar to any EMS disclosed herein (e.g., the EMS disclosed with respect to FIG. 2). For example, the EMS may autonomously control movement of the vehicle system by electrically communicating directions and/or commands to the systems and devices associated with the OVCS. The EMS can include hardware circuits or circuitry that include and/or are connected with one or more processors.

The OVCS can include a propulsion system 428. The propulsion system in the embodiment of FIG. 4 can be similar to any propulsion systems disclosed herein (e.g., the propulsion system disclosed with respect to FIG. 2). For example, the propulsion system provides tractive effort and/or braking effort of the propulsion-generating vehicle and system can include or represent one or more engines, motors, alternators, generators, brakes, batteries, turbines, and the like, that operate to propel the propulsion-generating vehicle and/or the vehicle system.

The OVCS can include a virtual control interface 424 and/or a physical control interface 444. The virtual control interface and/or the physical control interface can be similar to any input device disclosed herein (e.g., the input device disclosed with respect to FIG. 2). The physical control interface can represent one or more than one physical interface device for receiving inputs from an onboard operator to control movement of the vehicle system. The physical interface device(s) can include throttles, levels, pedals, buttons, etc. The virtual control interface can represent one or more than one screen-based device for receiving inputs from an onboard operator to control movement of the vehicle system. The screen-based device(s) can include a touch screen, a keyboard, an electronic mouse, etc.

The OVCS can include an operation support system 438 (e.g., an Automated Train Operation Support System (ATOSS)), which can be a control circuit. In other aspects, a suitable operation support system can include or represent a software module and/or virtual machine implemented by the OVCS. The operation support system can include or otherwise communicate with one or more than one sensor, such as the object detection sensor(s) disclosed with respect to FIG. 2. The operation support system can receive and process signals from the sensor(s) and generate commands implementable by the controller for controlling movement of the vehicle system.

The operation support system can receive a signal from a sensor and process the signal to determine an operating condition of the vehicle system (e.g., an operating condition of one or more engines, motors, alternators, generators, brakes, batteries, turbines of the propulsion system). The operation support system can generate a command that is implemented by the OVCS for controlling the movement of the vehicle system based at least in part on determining the operating condition. For example, the sensor signal may indicate that one of the components of the propulsion system is in a fault state (e.g., because of a malfunction of the component, because of a loss of communication with the corresponding sensor). Based at least in part on the sensor signal, the operation support system can generate a command for stopping motion of the vehicle system that is implemented by the controller and/or the propulsion system. Additionally, or alternatively, based at least in part on the sensor signal, the operation support system can cause the OVCS to transmit a request to the RVCS for remote control of movement of the vehicle system (e.g., by a remote operator).

As another example, the operation support system can receive a signal from a sensor and process the signal to detect an object proximate to the vehicle system, such as an object in a path of the vehicle system (e.g., point protection). For example, the sensor may comprise one or more than one object detection sensor (e.g., cameras, radar sensors, lidar sensors, ultrasonic sensors). A signal from the object detection sensor(s) may indicate that there is an object obstructing the path of the vehicle system. Based at least in part on the sensor signal, the operation support system can generate a command implementable by the controller and/or the propulsion system for navigating the vehicle system based at least in part on the detected object, such as stopping movement of the vehicle system, steering around the object, and/or slowing movement of the vehicle system (e.g., creeping forward). Additionally, or alternatively, based at least in part on the sensor signal, the operation support system can cause the OVCS to transmit a request to the RVCS for remote control of movement of the vehicle system (e.g., by a remote operator).

The OVCS includes a control circuit 436 that can receive signals from the virtual control interface, the physical control interface, the EMS, the operation support system, the RVCS, and/or a positive vehicle control system (PVC) 446 and based at least in part on the signals, the controller can control settings of propulsion system to control movement of the vehicle system. A suitable positive vehicle control system is the I-ETMS Positive Train Control system available from Wabtec Corporation.

The OVCS can include, or communicate with, the positive vehicle control system. The PVC system can include or otherwise represent various software and/or hardware circuitry that includes and/or is connected with one or more processors and/or communication device devices. The communication devices can receive signals from wayside devices indicating conditions of routes upon which the vehicle system may travel, locations of other and different vehicles, movement directions of those vehicles, occupancies of routes, speeds of those vehicles, etc. For example, the signals may indicate that an upcoming segment of a route is under repair, is occupied, contains an obstacle or is otherwise unavailable for travel. As another example, the communication device(s) may communicate with other vehicles to obtain and/or provide information on the conditions of previous or upcoming portions of the route (e.g., weather, presence of damage or another vehicle, etc.). The PVC system can generate a command for navigating the vehicle system based at least in part on the received signals. For example, the PVC system can generate a positive control command that is implemented by the controller to stop or slow (e.g., to satisfying a maximum speed threshold) movement of the vehicle system based at least in part on the received signals.

Still referring to FIG. 4, the operation support system can include a control mediation device 440 (e.g., an Automated Train Operation (ATO) Executive). In other aspects, the control mediation device can include or represent a software module and/or virtual machine implemented by the OVCS and/or the operation support system. The control mediation device can manage communications between the RVCS and the OVCS. For example, the control mediation device can manage transitions between operating the OVCS in an onboard control state (e.g., where commands from onboard systems such as the EMS, the physical control interface, and/or the virtual control interface control movement of the vehicle) and on offboard control state (e.g., where commands from the remote vehicle control system control movement of the vehicle). As another example, in situations where multiple commands are concurrently generated and/or received for controlling movement of the vehicle system (e.g., commands from the EMS, the virtual control interface, the physical control interface, the operation support system, and/or the RVCS) the control mediation device can determine which control command(s) to implement. As another example, the control mediation device can relay commands received by the OVCS from the RVCS to an onboard remote command manager, and the remote command manager can cause the commands from the RVCS to be implemented by the controller to control movement of the vehicle system. Although the embodiment of FIG. 4 shows the control mediation device as included in the operational support system, the control mediation device may be separate from the operation support system.

The EMS can include a remote command manager 448 as a control circuit. In other aspects, the remote command manager can include or represent a software module and/or virtual machine implemented by the OVCS. As explained further herein, the remote command manger can enable remote commands transmitted by the RVCS to the OVCS (e.g. to the control mediation device) to be implemented by the controller to control movement of the vehicle system. Although the embodiment of FIG. 4 shows the remote command manager as included in the EMS, the remote command manager may be separate from the EMS.

Still referring to FIG. 4, the RVCS can include an offboard control device 462 and an offboard control interface 464 as a control circuit. In other aspects, the offboard control device can include or represent a software module and/or virtual machine implemented by the OVCS. The offboard control device can manage communications between the RVCS and the OVCS (e.g., the control mediation device). For example, the offboard control device can receive a command signal from the offboard control interface and communicate the command signal to the OVCS for controlling movement of the vehicle system. As another example, the offboard control device can receive a request from the OVCS for a remote operator and execute various functions based at least in part on the request such as authenticating the OVCS and/or the vehicle system associated with the OVCS and establishing a secure link with the OVCS for communicating commands, as explained further herein. As another example, the offboard control device can execute various functions related to assigning a remote operator and/or a remote operating interface to an OVCS (e.g., based at least in part on receiving a request for a remote operator from the OVCS). As another example, the offboard control device can identify and select a communication channel of the network for establishing communications with the OVCS and/or identify and select another communication channel of the network to for establishing communications with the OVCS if there is a loss of communications over the first communication channel, as explained further herein.

A suitable offboard control interface can have input devices and output devices. The offboard control interface can include one or more than one device such as a touchscreen, keyboard, electronic mouse, microphone, and/or other input devices. The offboard control interface can receive inputs from the remote operator and generate command signals that are transmitted to the OVCS via the offboard communication device to change the tractive effort, braking effort, speed, power output, and the like, of the vehicle system.

The offboard control interface can include one or more than one output device such as a display screen (e.g., touchscreen or other screen), a speaker, a printer, and/or other output devices. The offboard control interface can present information to a remote operator of the vehicle system using the one or more than one output device. For example, the offboard control interface can present the identities and statuses of the vehicle(s) in the vehicle system, identities of missing vehicles (e.g., those vehicles from which the OVCS has not received the status), contents of one or more command messages, or the like based at least in part on signals received from the OVCS via the offboard control device. The offboard control interface can provide a notification signal to the remote operator of the vehicle system that automatically informs (e.g., notifies) the remote operator that control of the movement of the vehicle system has changed.

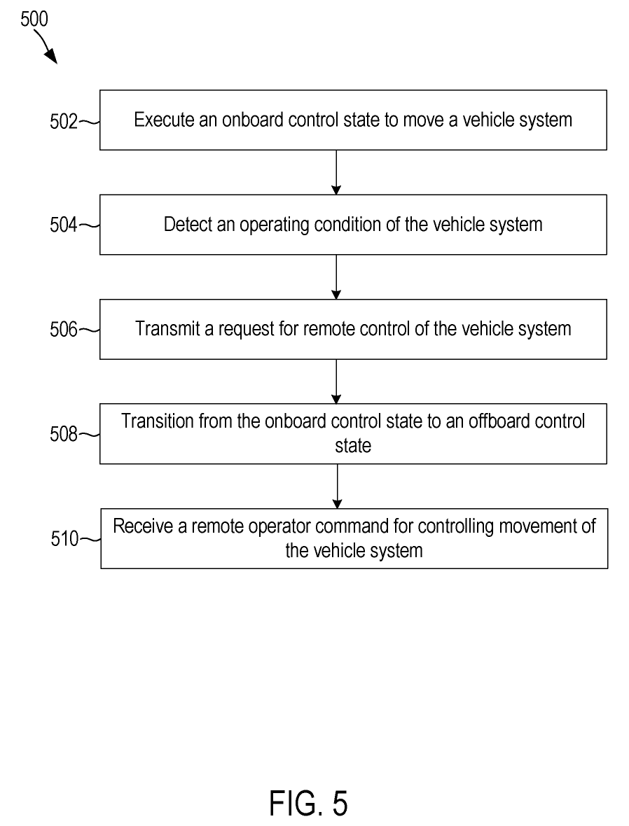

The OVCS and the RVCS can communicatively connect to enable remote operation of the vehicle system based at least in part on various scenarios and conditions. As explained further herein, for example, with respect to FIGS. 5-10, various control schemes and/or methods can be implemented by the OVCS and/or the RVCS to request remote control of movement of the vehicle system based at least in part on a detected operating condition, establish a secure communication link, verify that remote control of movement of the vehicle system by the RVCS is enabled, address situations where communication between the OVCS and the RVCS is interrupted, and manage the implementation of various control signals from various sources based at least in part on a control hierarchy. Any of the aspects disclosed with respect to FIGS. 5-10 can be implemented by any OVCS and/or RVCS disclosed herein, and/or any component(s) thereof disclosed herein.

FIG. 5 illustrates a flow diagram of one embodiment of a method 500 for requesting a remote operator to control movement of a vehicle system. According to the method, the OVCS executes 502 an onboard control state to move the vehicle system. For example, in the onboard control state, the EMS of the OVCS can be automatically controlling movement of the vehicle system based at least in part on a trip plan. In another example, in the onboard control state, an onboard operator can be controlling movement of the vehicle system based at least in part on providing inputs to an input device of the OVCS, such as, for example, on or more than one input device included in a virtual control interface and/or a physical control interface onboard the vehicle system. In various aspects of the method, the control mediation device can designate a status of the OVCS as operating in the onboard control state and manage control signals for controlling movement of the vehicle system based at least in part on the OVCS being in the onboard control state.

Still referring to FIG. 5, according to the method, the OVCS can detect 504 an operating condition of the vehicle system. For example, a sensor of the OVCS may detect an object obstructing a path of travel of the vehicle system. As another example, the positive vehicle control system may receive a signal indicting that movement of the vehicle system should be slowed or stopped. As another example, a sensor and/or other component of the OVCS may detect that a device and/or system of the vehicle system (e.g., the EMS system, the positive vehicle control system, the propulsion system or a component thereof, a sensor, an input device and/or output device) is in a fault state (e.g., malfunction, loss of communication with the OVCS). As another example, the OVCS can detect that the vehicle system has entered or is approaching designated geographical location or region. As another example, the OVCS can detect that an operational setting and/or an operating parameter of the propulsion system has satisfied a threshold (e.g., exceeded the maximum operational setting and/or operating parameter).

Still referring to FIG. 5, according to the method, the OVCS can transmit 506 a request for remote control of the vehicle system to the RVCS (e.g., to the offboard control device) based at least in part on detecting the operating condition. For example, the control mediation device may generate the request for the remote control of the vehicle system based at least in part on the OVCS detecting the operating condition. The control mediation device can cause a communication device of the OVCS to transmit the request for remote control to the RVCS. The offboard control device of the RVCS may receive the request.

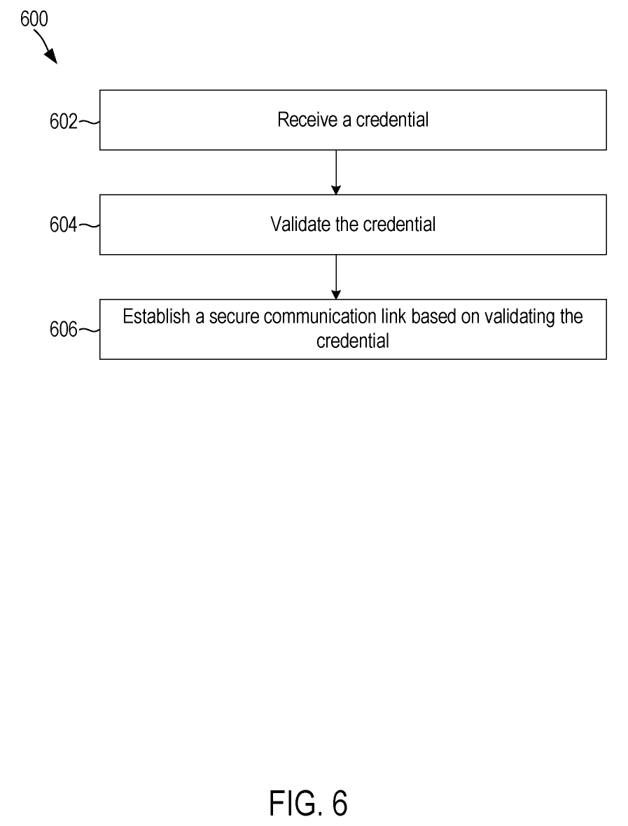

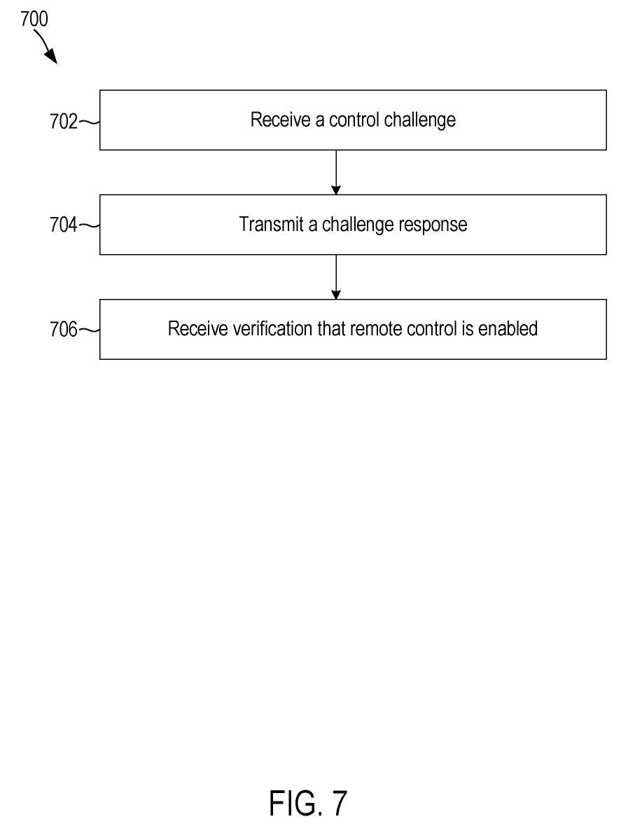

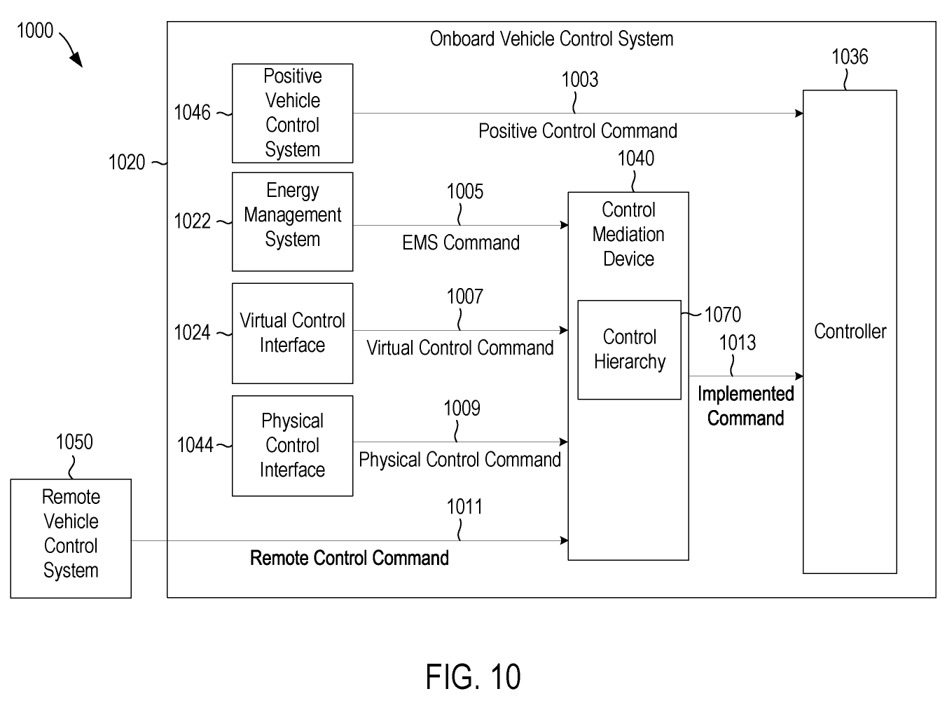

Still referring to FIG. 5, according to the method, the OVCS can transition 508 from the onboard control state to an offboard control state. For example, the OVCS (e.g., the control mediation device) and the RVCS (e.g., the offboard control device) can execute various protocols for authentication (e.g., authenticating the OVCS by the RVCS, authenticating the RVCS by the OVCS) and establishing a secure communication link. In one embodiment, the protocols for authentication can be similar to those described herein with respect to FIG. 6. As another example, the OVCS and the RVCS can execute various protocols for ensuring that the RVCS is enabled to remotely control movement of the vehicle system (e.g., execute a departure test). In one embodiment, the protocols for ensuring that the RVCS is enabled to remotely control movement of the vehicle system can be similar to those described herein with respect to FIG. 7. The control mediation device can designate a status of the OVCS as operating in the offboard control state and manage control signals for controlling movement of the vehicle system based at least in part on the OVCS being in the onboard control state, for example, according to the control hierarchy disclosed herein with respect to FIG. 10.

Still referring to FIG. 5, according to the method, the OVCS can receive 510 a remote operator command from the RVCS for controlling movement of the vehicle system. For example, the offboard control device of the RVCS can transmit the remote operator command to the OVCS based an input received from a remote operator via the offboard control interface. The control mediation device of the OVCS can receive the remote operator command. The control mediation device can cause the OVCS to implement the remote operator command, for example, by forwarding the remote operator command to the remote command manager, and the remote command manager can cause the controller to implement the remote operator command to control movement of the vehicle.

FIG. 6 illustrates a flow diagram of one embodiment of a method 600 for establishing a secure communication link between the OVCS and the RVCS. In one aspect, the method is performed by the OVCS to authenticate the RVCS. For example, it may be desirable for OVCS to authenticate the RVCS and establish a secure link with the RVCS to ensure that the RVCS is authorized to remotely control the vehicle system and/or to ensure that no unauthorized devices can send signals to the OVCS for controlling the vehicle system. In another aspect, the method is performed by the RVCS to authenticate the OVCS. For example, it may be desirable for the RVCS to authenticate the OVCS and establish a secure link with the OVCS to ensure that the OVCS is registered (e.g., subscribed) or otherwise authorized to receive remote control services by the RVCS. As described below, the method refers to a requesting control system and a validating control system. The RVCS can be the requesting control system and the OVCS can be the validating control system. Alternatively, the OVCS can be the requesting control system and the RVCS can be the validating control system.

Still referring to FIG. 6, according to the method, the validating control system receives 602 a credential from the requesting control system. In one embodiment, the requesting control system may transmit the credential concurrently with a request to communicate with or otherwise access the validating control system (e.g., with a request for remote control of the vehicle system, as discussed with respect to FIG. 5). A suitable credential can include an identifier corresponding to the requesting control system (e.g., an identifier of the OVCS and/or the corresponding vehicle system, an identifier of the RVCS). A suitable identifier may be stored by a memory of the requesting control system, and may be tokenized or otherwise encrypted by the requesting control system prior to transmitting the identifier to the validating control system. For example, the identifier may be encrypted using a cryptographic key (e.g., a symmetric key, a public or private key of an asymmetric key pair) an encryption algorithm (e.g., a triple data encryption standard (Triple DES) algorithm, an advanced encryption standard (AES) algorithm). In one embodiment, the credential may include an identifier for the vehicle system, an identifier for the offboard control system, and validation information. Other information may include a time/date stamp, location data, equipment model information, and the like.

Still referring to FIG. 6, according to the method, the validating control system validates 604 the credential. For example, the validating control system may compare the credential (e.g., the identifier) to a database of credentials. The database may be stored in a memory of the validating control system or in a memory of a server in communication with the validating control system. In one embodiment, the database of credentials may correspond to users (e.g., organizations, companies, individuals) who have a subscription to use remote control services related to the RVCS. The validating control system can validate the received credential based at least in part on identifying a matching credential in the database of credentials.

Additionally, or alternatively, the validating control system may validate the received credential based at least in part on the tokenized or otherwise encrypted identifier. For example, the validating control system may decrypt the tokenized or otherwise encrypted identifier using the corresponding cryptographic key (e.g., a symmetric key, a public or private key of an asymmetric key pair). As another example, the validating control system may validate the received credential based at least in part on tokenizing or otherwise encrypting credentials stored in the database of credentials (e.g., using the same encryption algorithm and key applied by the requesting control system) and identifying a match between the tokenized or otherwise encrypting credential received from the requesting control system and the tokenized or otherwise encrypting credentials from the database.

Still referring to FIG. 6, according to the method, the validating control system establishes 606 a secure communication link with the requesting control system based at least in part on validating the credential. For example, based at least in part on validating the credential, the validating control system can allow further communication (e.g., transmitting and/or receiving of command signals and other data) between the validating control system and the requesting control system.

FIG. 7 illustrates a flow diagram of one embodiment of a method 700 to verify that remote control of movement of the vehicle system by the RVCS is enabled. Communication between the RVCS and the OVCS can be established according to various methods and/or protocols described herein. With an established connection, it may be desirable to verify that the commands transmitted by the RVCS are implementable by the OVCS and/or to verify that a remote operator is present at the RVCS, for example, to ensure that the RVCS is enabled to remotely control movement of the vehicle system.

Still referring to FIG. 7, according to the method, the RVCS (e.g., the offboard control device) may receive 702 a control challenge from the OVCS (e.g. the control mediation device). The control challenge can be a request for the RVCS to transmit a control signal back to the OVCS for the OVCS to implement. For example, control challenge can be a request for the RVCS to transmit a specific type of command to the OVCS, such as a command that would cause the OVCS to change an operating parameter of the vehicle system (e.g., an operating parameter of the propulsion system). As another example, the control challenge can be a request for the RVCS to transmat a signal to the OVCS that enables the OVCS to verify implementable commands can be sent by the RVCS to the OVCS (e.g., a signal that would not otherwise change an operating parameter of the vehicle system). The control challenge can comprise instructions displayable to a remote operator by the RVCS requesting the corresponding command and/or signal. For example, the instructions may ask the operator to provide a specific input to the offboard control interface.

In some examples, the control challenge may be used to verify the presence of a remote operator. For example, the control challenge can be a request for the RVCS and/or a remote operator to provide conformation that the remote operator is capable of remotely controlling movement of the vehicle system and/or remotely supervising the control of movement of the vehicle system. The control challenge may request the above conformation to be provided via a signal corresponding to an image capture by a camera of the offboard control interface and/or audio capture by a microphone of the offboard control interface.

Still referring to FIG. 7, according to the method, the RVCS transmits 704 a challenge response to the OVCS. The challenge response can correspond to the command and/or signal requested by the RVCS. The challenge response may be transmitted based at least in part on an input provided by the operator to the offboard control interface. For example, the operator may provide an input corresponding to the requested command. The offboard control interface can generate the requested command and/or signal based at least in part on the input. The offboard control device can transmit the requested command and/or signal to the OVCS. The OVCS can receive the command and/or signal. In some examples, the OVCS may attempt to implement the command and/or signal. The OVCS can detect whether the command and/or signal was successfully implemented (e.g., detect whether a corresponding parameter of the vehicle system was changed). In some examples, the OVCS may validate or otherwise confirm the presence of a remote operator in response to receiving the signal. The OVCS can transmit a response to the RVCS indicating whether the command and/or signal was successfully implemented and/or validated.

Still referring to FIG. 7, according to some aspects of the method, the RVCS receives 706 a verification from the OVCS that remote control and/or remote supervision is enabled. For example, the RVCS can receive the verification from the OVCS that remote control is enabled based at least in part on the OVCS transmitting the response to the RVCS indicating that command and/or signal was successfully implemented and/or validated. The RVCS may proceed to transmit commands to the OVCS for remotely controlling movement of the vehicle system based at least in part on receiving the verification that remote control is enabled. According to some aspects of the method, the RVCS may not receive the verification from the OVCS that remote control is enabled. For example, the OVCS may transmit a response to the RVCS indicating that the command and/or signal was not successfully implemented. This may cause the RVCS and/or the OVCS to attempt the above verification process again. Additionally, or alternatively, without verification that remote control is enabled, the OVCS may be prevented from entering an offboard control state and/or the OVCS may prevent movement of the vehicle system.

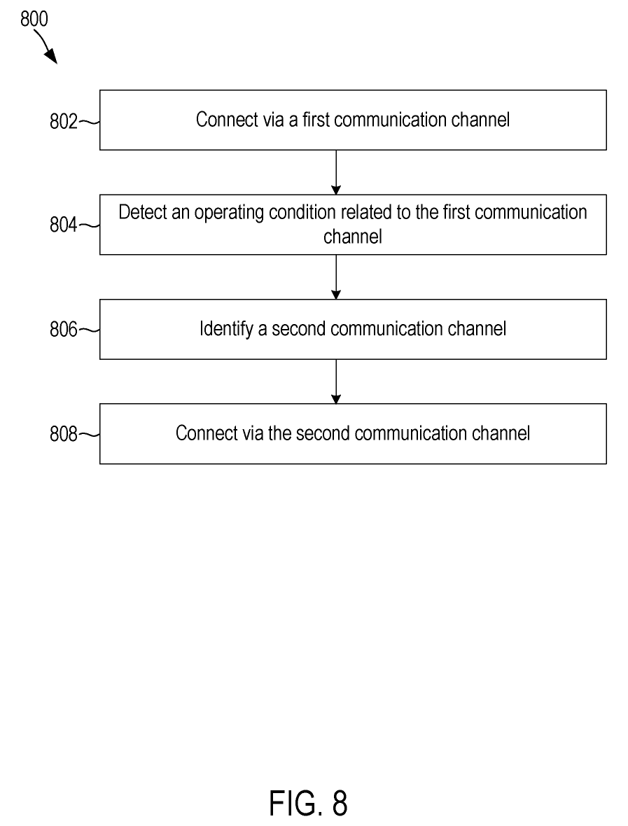

FIG. 8 illustrates a flow diagram of one embodiment of a method 800 for switching communication channels for communication between the OVCS and the RVCS. As discussed further herein, the OVCS and the RVCS can communicate via a network. The network can include multiple different communications channels corresponding to communication networks of different types and/or multiple of the same type of communication network. The method can be performed by the OVCS, the RVCS, and/or both the OVCS and the RVCS. As described below, the method refers generically to a control system.

Still referring to FIG. 8, according to the method, the control system connects 802 to the network via a first communication channel. The control system may connect via the first communication channel based at least in part on a connection preference, such as, for example, a conditional connection preference. For example, the control system may correspond to the OVCS. The OVCS may select the first communication channel based at least in part on discovering available communication channels in the network and, based at least in part on the conditional connection preference, select the first communication channel as the highest ranked (e.g., most preferred) communication channel of the available communication channels. As another example, the OVCS may select the first communication channel based at least in part on determining geographic locations that the vehicle system will travel in during a trip plan and, based at least in part on the conditional connection preference, select the first communication channel as the highest ranked (e.g., most preferred) communication channel of the available communication channels for the geographic locations. As another example, the control system may correspond to the RVCS. The RVCS may determine that the OVCS is connected to the network via the first communication and connect via the first communication channel based at least in part on the OVCS being connected via the first communication channel.

Still referring to FIG. 8, according to the method, the control system detects 804 an operating condition related to the first communication channel. For example, the control system may detect a loss of connection to the first communication channel. As another example, the control system may detect or otherwise determine that vehicle system is approaching a geographic location where connection to the first communication channel is not preferred. As another example, the control system may detect a fault condition related to a device of the control system used to connect via the first communication channel.

Still referring to FIG. 8, according to the method, the control system identifies 806 a second communication channel of the network. The control system can identify the second communication channel based at least in part on the connection preference (e.g., the conditional connection preference). For example, the control system may correspond to the OVCS. The detected operating condition may be a loss of connection via the first communication channel. The OVCS may select the second communication channel based at least in part on discovering available communication channels in the network and, based at least in part on the conditional connection preference, select the second communication channel as the highest ranked (e.g., most preferred) communication channel of the available communication channels. As another example, the OVCS may select the second communication channel based the second communication channel being the highest ranked (e.g., meeting determined criteria) communication channel of the available communication channels for a current and/or anticipated geographic location of the vehicle system. As another example, the control system may correspond to the RVCS. The RVCS may detect that the OVCS has switched from the first communication to the second communication channel and identify the second communication channel based at least in part on detecting the switch of communication channels.

According to some aspects of the method, the control system may not be able to identify a second communication channel. For example, the control system may be the OVCS. The OVCS may lose connection to the network via the first communication channel, may not be able to identify and/or discover a second communication channel of the network, and therefore may not be able to receive commands from the RVCS for remotely controlling movement of the vehicle system. In this scenario, the OVCS (e.g., the control mediation device), may be configured to switch from an offboard control state to an onboard control state. The OVCS may issue an alert (e.g., via an output device) and/or request an onboard operator. The OVCS may transfer to control to the EMS and operate in an automatic control state. The OVCS (e.g., the operation support system) may generate a penalty command to stop movement of the vehicle system.

Still referring to FIG. 8, according to some aspects of the method, the control system connects 808 to the network via the second communication channel. The control system (e.g., the OVCS, the RVCS) can transmit and/or receive commands for controlling movement of the vehicle system via the second communication channel.

In some examples, the OVCS and/or the RVCS may evaluate a quality of a communication channel before enabling remote control and/or remote supervision of the OVCS by the RVCS. For example, the OVCS and/or the RVCS may determine end-to-end latency and/or jitter, communication channel reliability, communication channel bandwidth in real time. The OVCS and/or the RVCS may compare any of the end-to-end latency and/or jitter, communication channel reliability, communication channel bandwidth to one or more thresholds and enabling remote control and/or remote supervision of the OVCS by the RVCS based determining that the one or more thresholds are satisfied.

In some examples, the OVCS and/or the RVCS may access a database that includes a list of available and/or approved communication channels. The available and/or approved communication channels may correspond to geographic areas, such as geographic locations along a route. The OVCS and/or the RVCS may automatically switch from a first communication channel to a second communication channel based, at least in part, on the list of available and/or approved communication channels. For example, the OVCS and/or the RVCS may automatically switch from a first communication channel to a second communication channel as the vehicle system travels along a route from a first geographic area associated with the first communication channel to a second geographic area associated with the second communication channel.

In some examples, the OVCS and/or the RVCS may automatically update various parameters based on one or more indicators of a performance of a communication channels (e.g., end-to-end latency and/or jitter, communication channel reliability, communication channel bandwidth). For example, the OVCS and/or the RVCS may update or otherwise modify a resolution and/or frame rate of transmitted video, modify a data rate of status and/or command transmissions, and/or may shift data load to a best performing communication channel.

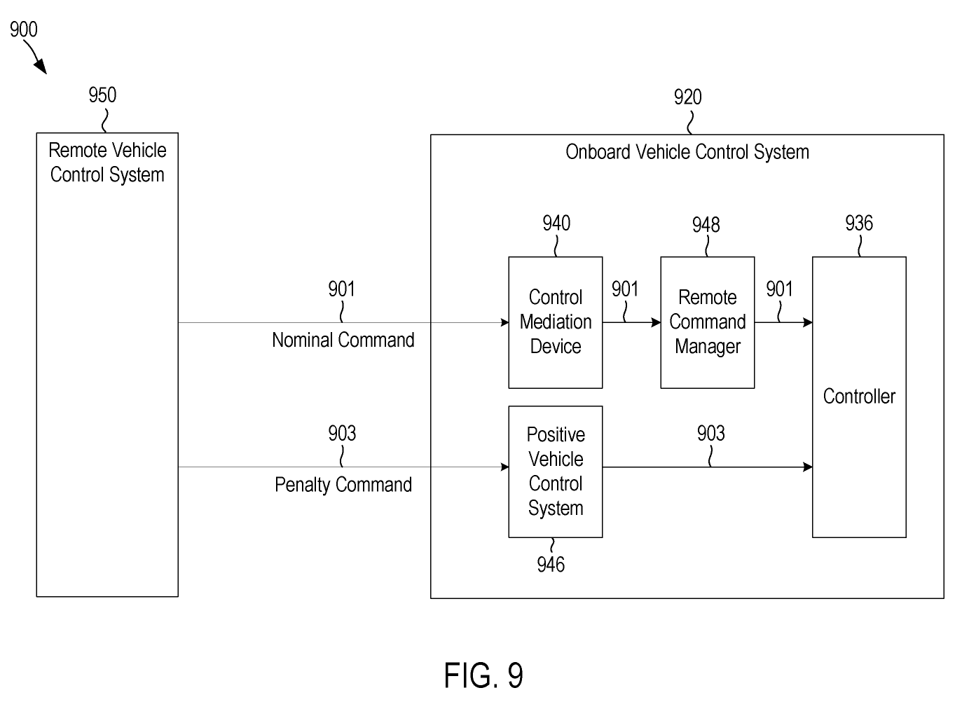

FIG. 9 is a schematic illustration of one embodiment of a control scheme 900 for managing remote commands. The control scheme can be implemented by an onboard vehicle control system (OVCS) 920 receiving commands from a remote vehicle control system (RVCS) 950. The OVCS and the RVCS can be similar to any OVCS and RCVS disclosed herein. The OVCS includes a control mediation device 940, a positive vehicle control (PVC) system 946, a remote command manager 948, and a controller 936. The control mediation device, the PVC system, the remote command manager, and the controller can be similar to any control mediation device, PVC system, remote command manager, and controller disclosed herein.

The commands sent by the RVCS to the OVCS can include a nominal command 901 and a penalty command 903. A nominal command can be any type of command for controlling movement of a vehicle system, for example, under nominal conditions (e.g., commands for controlling movement of the vehicle system that are not penalty commands). For example, the nominal command can be a command to control a throttle power setting (e.g., notch), a break setting, or another type of command to control a setting of the propulsion system. A penalty command can a command for stopping movement of a vehicle system, for example, under a penalty condition (e.g., emergency stop).

The nominal command is received by the control mediation device of the OVCS. The control medication device forwards the nominal command to the remote command manager. The remote command manager forwards the nominal command to the controller. The remote command manager can act as a bridge between the control mediation device and the controller to enable the controller to implement remote commands from the RVCS. The controller can implement the command, for example, by adjusting a corresponding setting of the propulsion system, thereby controlling movement of the vehicle system.

The penalty command is received by the positive vehicle control system. The positive vehicle control system forwards the penalty command to the controller, for example, directly and without passing the penalty command through the remote command manager. The controller can implement the command, for example, by adjusting a corresponding setting of the propulsion system, thereby controlling (e.g., stopping) movement of the vehicle system. It may be desirable to forward the penalty command to the controller directly and without passing the penalty command through the remote command manager to minimize potential failure modes related to implementing the penalty command.

In one embodiment, the control medication device and the positive vehicle control system may be software modules and/or virtual machines implemented by a common hardware component of the OVCS. Thus, both the nominal command and the penalty command may be transmitted from the RVCS to the common hardware component and may be routed to the control medication device or the positive vehicle control system based at least in part on the command type.

FIG. 10 is a schematic illustration of one embodiment of a control scheme 1000 for managing commands. The control scheme can be implemented by an onboard vehicle control system (OVCS) 1020 generating commands and/or receiving commands from a remote vehicle control system (RVCS) 1050, a positive vehicle control (PVC) system, an energy management system (EMS) 1022, a virtual control interface 1024, and/or a physical control interface 1044. The OVCS includes a control mediation device 1040 for managing various commands and a controller 1036 for implementing various commands to control movement of the vehicle system. The OVCS, RVCS, PVC system, EMS, virtual control interface, physical control interface, control medication device, and controller can be similar to any other OVCS, RVCS, PVC system, EMS, virtual control interface, physical control interface, control medication device, and controller disclosed herein.

The PVC system can generate a positive control command 1003, for example, based at least in part on a signal received from a wayside device. The EMS system can generate an EMS command 1005 to control movement of the vehicle system, for example, based at least in part on a trip plan. The virtual control interface can generate a virtual control command 1007 to control movement of the vehicle system, for example, based at least in part on an input received from an operator onboard the vehicle system. The physical control interface can generate a physical control command 1009 to control movement of the vehicle system, for example, based at least in part on an input received from an operator onboard the vehicle system. The RVCS can generate a remote control command 1011 to control movement of the vehicle system, for example, based at least in part on an input received from a remote operator offboard the vehicle system. The EMS command, the virtual control command, and the physical control command each may be considered an onboard operator command. The remote control command may be considered an offboard operator commands.

There may be scenarios where multiple commands are generated and/or received by the OVCS concurrently (e.g., close enough in time such that attempting to implement two or more of the commands may cause a control conflict). For example, an onboard operator may cause the physical control interface to generate a physical control command while another onboard operator may cause the virtual control interface to generate a virtual control command. As another example, an offboard operator may cause the RVCS to generate and transmit a remote control command while an onboard operator causes the virtual control system to generate a virtual control command. The various commands may conflict with one another and the system may implement a scheme to determine whether to implement a particular command.

A suitable control mediation device may include or otherwise implement a control hierarchy 1070 determine whether to implement a particular command. The control hierarchy can be, for example, an algorithm (e.g., a rule-based algorithm) and/or a machine learning model configured to determine whether to implement a command. For example, if one or more than one command (e.g., the remote control command, the physical control command, the virtual control command, and/or the EMS command) is generated and/or received, the command(s) can be routed to or otherwise analyzed by the control mediation device. Based at least in part on the control hierarchy, the control mediation device can determine whether to forward the command(s) to the controller as an implemented command 1013 to control movement of the vehicle system.

A suitable control hierarchy may include various rules for determining whether to implement a command. In one embodiment, the control hierarchy can include rules that designate preferences for implementing commands based at least in part on the source of the commands. For example, the rules can designate a preference for implementing a physical control command over a virtual control command, or vice versa. As another example, the rules can designate a preference for implementing an offboard operator command (e.g., a remote control command) over an onboard operator command (e.g., a physical control command, a virtual control command, an EMS command), or vice versa. As yet another example, the rules can designate a preference for implementing a manual command (e.g., a physical control command, a virtual control, a remote control command) over an automated command (e.g., an EMS command), or vice versa. The present disclose envisions embodiments of the control hierarchy including rules corresponding to any potential preferential ranking of the commands based at least in part on their source.

In one embodiment, the control hierarchy can include rules that designate preferences for implementing commands based command types. For example, any of the physical control command, the virtual control, the remote control command, and the EMS command may be a nominal command (e.g., a command for controlling movement of a vehicle system, for example, under nominal conditions) or a penalty command (e.g., a command for stopping movement of a vehicle system, for example, under a penalty condition). The rules may designate a preference for implementing a penalty command over a nominal command, or vice versa. As another example, command types may be classified and given preference based at least in part on the component of the vehicle system the commands are intended to control (e.g., engines, motors, alternators, generators, brakes, batteries, turbines).

In one embodiment, the control hierarchy can include rules that designate preferences for implementing commands based at least in part on both command types and the source of the commands. For example, if a first control source and a second control sources both generate a command, and the first control source is preferred over the second control source, but the type of command from the second control source is preferred over the type of command from the first control source, then the type of command may dominate the control hierarchy and the command from the second control source may be implemented over the command from the first control source. As another example, the source of the command may dominate the control hierarchy and the command from the first control source may be implemented over the command from the second control source.

In one embodiment, the control hierarchy (e.g., a conditional control hierarchy) can include conditional rules, such as, rules that consider operational conditions and/or other factors to determine whether to implement a command. In one aspect, the rules may be conditioned based at least in part on a control state of the OVCS and/or a control state of the control mediation device. For example, the OVCS and/or the control mediation device may designate an onboard control state and an offboard control state. The offboard control state may correspond to a state where the OVCS is communicatively coupled to (e.g., via a secure communication link) or otherwise enabled to receive commands from the RVCS and the onboard control state may correspond to a state where the OVCS is not is communicatively coupled to or otherwise enabled to receive commands from the RVCS. A first set of rules (e.g., preference rankings for command sources and/or command types as explained further herein) may be applied in the offboard control state and a second set of rules (e.g., different preference rankings) may be applied in the offboard control state. In other aspects, the rules may be conditioned based other operating conditions and/or factors such as current geographic location of the vehicle system, an anticipated geographic location of the vehicle system, a current segment of a trip the vehicle system is traveling, an anticipated segment of a trip the vehicle system is traveling, a fault condition of the vehicle system and/or a component thereof detected by the OVCS, a condition of the positive control system, or various other operating conditions and/or factors.

The control hierarchy can implement a machine learning model configured to determine whether to implement a command. For example, the control hierarchy can include a machine learning model that is trained based at least in part on training data and/or updated based at least in part on operational data. The training data can include data (e.g. labeled data, unlabeled data) including command decisions related historical operation of similar control systems and/or vehicle systems. The operational data can be data collected during operation of the vehicle system and used to retrain or otherwise update the machine learning model.

Referring still to FIG. 10, the positive control command may be transmitted (e.g., directly) to the controller and/or may not be routed to or otherwise analyzed by the control mediation device. The positive control command may therefore bypass the control mediation device and may override other implemented command forward by the control mediation device to the controller. For example, the positive control command may include a command to stop movement of the vehicle system. The command to stop movement of the vehicle system may override other commands, such as an EMS command, a virtual control command, a physical control command, and/or a remote command. In other embodiments, the positive control command may be routed to and/or otherwise analyzed by the control mediation device according to the control hierarchy.

In some examples, the OVCS and/or the RVCS may implement various operational schemes. For example, the OVCS may enable or disable autonomous control of movement of the vehicle system based on a geographic location of the vehicle system. As the vehicle system approaches or enters a geographic area were autonomous control of movement of the vehicle system is disabled, the OVCS and/or the RVCS may transition to a remote control mode where the RVCS remotely controls movement of the vehicle system. As another example, the OVCS and/or the RVCS may enable remote supervision and/or monitoring of the OVCS and/or an onboard operator by a remote operator at any time.

Referring again to FIG. 4, in some embodiments, when the OVCS and the RCVS may be communicatively coupled. While communicatively coupled the remote command manager, the control mediation device, and the offboard control device may operate as synchronized state machines. For example, each of the remote command manager, the control mediation device, and the offboard control device may be virtual machines. Each of the virtual machines may existing in a plurality of different states. The states that the virtual machine exist in can dictate or otherwise correspond to the control state (e.g., operating parameter state) of the controller and/or the other components of the vehicle system. It may be desirable for the virtual machines to synchronize their corresponding states so that each virtual machine accurately represents the control state of the controller and other components of the vehicle system.

To synchronize the states of each of the virtual machines, one of the virtual machines may operate as a primary virtual machine and the other virtual machines may operate as secondary virtual machines. The primary virtual machine and the secondary virtual machines can communicate by transmitting and receiving messages. The primary virtual machine can transmit a message to one or more of the secondary virtual machines instructing the secondary virtual machines transition to or otherwise exist in a particular state. The secondary virtual machines can enter the instructed state. Further, each of the secondary virtual machines can transmit a message that is received by the primary virtual machine indicating the current state of the secondary virtual machines (e.g., indicating whether or not the secondary virtual machines are in the particular state instructed by the primary virtual machine). The messaging between the primary virtual machine and the secondary virtual machines can iteratively continue in this manner to synchronize the states of the virtual machines, for example, while the RVCS and the OVCS are communicatively linked. A combination of the remote command manager, the control mediation device, and the offboard control device may act as the primary virtual machine. For example, the remote command manager can act as the primary virtual machine and dictate the states of the control mediation device and the offboard control device. As another example, the control mediation device or the offboard control device may act as the primary virtual machine.

The foregoing description presents various embodiments of systems and processes through block diagrams, flowcharts, and examples. Each of the depicted components, functions, or operations may be implemented using hardware, software, firmware, or combinations thereof. Specific features can be executed using integrated circuits, computer programs, or processors (e.g., microprocessors, microcontrollers), as well as other software-hardware combinations. The design and development of such implementations, whether via circuitry or software, are within the technical expertise of those skilled in the art. Moreover, the described methods and mechanisms may be distributed as program products on various media, with no restriction on the format of the medium.

Instructions for implementing these features can be stored in various types of memory, including dynamic random-access memory (DRAM), flash memory, and/or cache. These instructions can also be distributed over a network or via other computer-readable media. The term "non-transitory computer-readable medium" refers to any physical medium capable of storing or transmitting instructions or information that can be read by a machine. Examples include, but are not limited to, optical disks, CD-ROMs, RAM, ROM, EPROM, EEPROM, magnetic or optical cards, flash memory, or even propagated signals such as carrier waves or infrared signals.

Software components described herein may be implemented using languages such as Python, Java, C++, or Perl. The corresponding software code may be stored on various computer-readable media, such as RAM, ROM, hard drives, or CD-ROMs. These media may be part of a single computational device or distributed across multiple devices within a networked system.

The term "control circuit" encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems -on -chips (SoCs), and are commonly found in devices such as computers, smartphones, and servers. These circuits may perform tasks involving data processing, communication, or data storage.

In some embodiments, the control circuit can utilize machine learning (ML) techniques to make decisions based on sensor inputs or other data. ML methods may include supervised learning (with labeled inputs and outputs), unsupervised learning (for identifying patterns), or reinforcement learning (where the system adapts based on feedback). tasks for ML systems may involve classification, regression, clustering, anomaly detection, or optimization, with algorithms such as decision trees, deep learning, support vector machines (SVMs), or neural networks being employed, depending on the application.

A control circuit may also incorporate a policy engine that applies specific rules based on equipment characteristics or environmental conditions. For instance, a neural network could process sensor data or operational inputs to determine appropriate actions. techniques such as backpropagation or evolutionary strategies may be used to refine neural network parameters and optimize model selection for the given task.

The system may handle data generation, transmission, and storage, potentially leveraging both protected and exposed data sources. Encryption and decryption can be applied during data transit, at rest, or in use, with keys and schemas determined based on operational needs. The control circuit may monitor and enforce decision boundaries, ensuring that data from protected sources meets safety or operational thresholds. If data breaches these boundaries, the system may initiate actions such as equipment shutdown, component isolation, or transitioning to safe mode to mitigate potential risks or damages.

In one embodiment, the control circuit, controller, and systems described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

In one embodiment, the control circuit may include a policy engine. The policies the engine may apply can be based at least in part on characteristics of a given item of equipment or environment. For example, an artificial intelligence system, such as a neural network, can receive input of a number of environmental and task-related parameters. These parameters may include, for example, operational input of the given equipment, data from various sensors, environmental information, location and/or position data, and the like. The neural network can be trained and can generate an output based on these inputs, with the output representing an action or sequence of actions that the equipment or system should take to accomplish the goal of the operation. The control circuit can process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network can be generated and adjustments to the parameters can be made with subsequent simulations. Once the outputs from the various models have been obtained, they may be evaluated on their performance using a determined success metric. The best model is selected, and the control circuit can execute that plan to achieve the desired input data to mirror the predicted best outcome scenario. Additionally, the success metric itself may be a combination of the optimized outcomes, which may be weighed relative to each other. Success metrics may be dynamically established, and the process rerun and the equipment directions further modified.

In one embodiment, data can be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

The term "logic" refers to software, firmware, and/or circuitry configured to execute the described operations. Logic may be implemented as applications, software packages, instruction sets, or data stored on non-transitory computer-readable storage media. Firmware may be hard-coded into memory devices. Components and modules described herein may be hardware, software, or a combination thereof, and may be in active, inactive, or standby states depending on system requirements.

An "algorithm" refers to a sequence of steps designed to achieve a specific result. These steps may manipulate physical quantities, typically in the form of electrical or magnetic signals, which are represented as bits, values, symbols, or numbers. The terms used to describe these processes are labels for the underlying physical operations.

The system may operate over a packet-switched network using various communication protocols, including Ethernet (complying with IEEE 802.3 standards), X.25, frame relay, or Asynchronous Transfer Mode (ATM). Communication between devices may follow established protocols such as TCP/IP or new emerging standards.

Terms such as "processing," "computing," "calculating," or "determining" refer to operations carried out by computing systems or electronic devices, which manipulate data represented as physical (electronic) quantities within memory or registers.

Terms like "component," “system," and "module" refer to computer-related entities, whether hardware, software, or a combination thereof. One or more components may be described as "configured to," "configurable to," "operable/operative to," "adapted/adaptable to," or similar terms. Unless explicitly stated, these terms encompass components in both active and inactive states.

Unless stated otherwise, terms like "including" or "having" should be interpreted as open-ended (i.e., "including but not limited to"). Numeric claim recitations generally mean "at least" the stated number, and disjunctive terms like "A or B" should be interpreted to include either or both unless explicitly specified. Operations in any claim may generally be performed in any order unless explicitly stated. The recitation "at least one of A, B, and C" should be interpreted as any combination of A, B, and C, such A alone, B alone, C alone, A and B together, A and C together, B and C together, and/or A, B, and C together. The recitation "at least one of A, B, or C" should be interpreted to include A alone, B alone, C alone, A and B together, A and C together, B and C together, and/or A, B, and C together.

In summary, various embodiments have been described to illustrate the principles and applications of the disclosed systems and methods. These descriptions are not intended to limit the scope of the invention, and variations may be made by those skilled in the art. The accompanying claims define the invention's broadest legal scope within its spirit and scope.

What is claimed is:

1. A vehicle control system, comprising:
an onboard control circuit configured to implement commands for controlling movement of a vehicle, and the onboard control circuit is further configured to:
receive a remote operator command for controlling the movement of the vehicle from an offboard device;
receive an onboard operator command for controlling the movement of the vehicle from an onboard control interface; and
determine whether to implement the remote operator command or the onboard operator command.

2. The vehicle control system of claim 1, wherein the remote operator command conflicts with the onboard operator command.

3. The vehicle control system of claim 1, wherein the onboard control circuit is configured to determine whether to implement the remote operator command or the onboard operator command based at least in part on a control hierarchy.

4. The vehicle control system of claim 3, further comprising a positive vehicle control system configured to:
receive a positive control signal; and
responsive to receiving the positive control signal, override the onboard control circuit implementing at least one of the remote operator command or the onboard operator command.

5. The vehicle control system of claim 1, wherein the onboard control circuit is further configured to control the movement of the vehicle based at least in part on a trip plan.

6. The vehicle control system of claim 5, wherein the onboard control circuit is further configured to transition from an onboard control state to an offboard control state based at least in part on an operating condition of the vehicle.

7. The vehicle control system of claim 1, wherein the onboard control circuit is configured to determine whether to implement the remote operator command or the onboard operator command based at least in part on a machine learning model or artificial intelligence program.

8. A vehicle control system, comprising an offboard device configured to:
receive a remote control request from an onboard control circuit of a vehicle, and the remote control request includes a credential;
establish a communication link for remotely controlling a movement of the vehicle based at least in part on validating the credential; and
transmit a remote operator command through the communication link to the onboard control circuit to control the movement of the vehicle.

9. The vehicle control system of claim 8, wherein the offboard device is further configured to:
receive a control challenge from the onboard control circuit; and
transmit a challenge response to the onboard control circuit to verify that remote control of the movement of the vehicle by the offboard device is enabled.

10. The vehicle control system of claim 8, wherein the onboard device is further configured to execute a determined set of instructions to resolve a conflict between onboard originated commands and offboard originated commands

11. The vehicle control system of claim 10, wherein the remote operator command slows or stops movement of the vehicle.

12. The vehicle control system of claim 10, wherein the remote operator command defers to an onboard control override signal.

13. The vehicle control system of claim 8, wherein the offboard device is restricted or blocked from handover of vehicle control from the onboard control circuit if the vehicle is moving at or above a determined speed, is at or within a determined location, is not within a determined location, or is performing a determined action or activity.

14. The vehicle control system of claim 8, wherein the remote control request is based at least in part on a change in an operating condition of the vehicle detected by the onboard control circuit.

15. The vehicle control system of claim 8, wherein the remote control request is responsive at least in part to a positive control signal.

16. An onboard control circuit for a vehicle configured to:
operate the vehicle based at least in part on a trip plan;
establish a communication link with an offboard device using a credential; and
transition control of the vehicle from the onboard control circuit to the offboard device.

17. The control circuit of claim 16, wherein the onboard control circuit is configured to transmit an image of an onboard operator, an audio recording of an onboard operator, or both an image and an audio recording of an onboard operator to the offboard device.

18. The control circuit of claim 16, wherein the onboard control circuit is configured to:
establish the communication link via a first communication channel;
detect an operating condition related to the first communication channel; and
establish the communication link via a second communication channel.

19. The control circuit of claim 16, wherein the onboard control circuit is configured:
transmit a control challenge to the offboard device;
receive a challenge response from the offboard device;
verify the challenge response; and
transition the control of the vehicle from the onboard control circuit to the offboard device based, at least in part, on verifying the challenge response.

20. The control circuit of claim 16, wherein the onboard control circuit is configured to determine whether to implement an onboard control command or a remote control command based, at least in part, on transitioning control of the vehicle from the onboard control circuit to the offboard device.
